(19) United States
(12) Patent Application Publication
(10) Pub. No.: US 2010/0147130 A1
(43) Pub. Date: Jun. 17, 2010

(54) FATIGUE-RESISTANCE SHEET SLITTING METHOD AND RESULTING SHEET

(75) Inventors: Max W. Durney, San Francisco, CA (US); Alan D. Pendley, Petaluma, CA (US); Justin Koch, Deer Creek, CA (US)

Correspondence Address: MORGAN, LEWIS & BOCKIUS, LLP (SF), ONE MARKET SPEAR STREET TOWER, SAN FRANCISCO, CA, 94105, US

(73) Assignee: Industrial Origami, Inc., San Francisco, CA (US)

(21) Appl. No.: 12/710,311

(22) Filed: Feb. 22, 2010

Related U.S. Application Data
(63) Continuation of application No. 11/180,398, filed on Jul. 12, 2005.
Application No. 11/180,398 is a continuation-in-part of application No. 10/672,766, filed on Sep. 26, 2003, now Pat. No. 7,152,449.
Application No. 10/672,766 is a continuation-in-part of application No. 10/256,870, filed on Sep. 26, 2002, now Pat. No. 6,877,349.
Application No. 10/256,870 is a continuation-in-part of application No. 09/640,267, filed on Aug. 17, 2000, now Pat. No. 6,481,259.
(60) Provisional application No. 60/587,470, filed on Jul. 12, 2004.

(51) Int. Cl. B21D 5/00; B26D 3/08; B21D 31/00

(52) U.S. Cl. 83/880; 72/379.2; 428/595

(57) ABSTRACT

A sheet of material (111) having a plurality of bend-inducing structures (113) configured and positioned to produce bending along a bend line (115). The bend-inducing structures (113) have arcuate return portions (122) extending from opposite ends (121) back along the bend-inducing structures (113) toward the other return portion (122) and each return portion (122) has a length dimension and a radius of curvature reducing stress concentrations. Preferably, the length dimension of the arcuate return portion (122) is in excess of twice the thickness. The lateral distance, LD, to which the bend-inducing structures (113) is formed in the sheet away from the bend line (115) is preferably minimized by small radius arcs (125) which connect the return portions (122) to the remainder of the bend-inducing structures (113). A method of forming a structure (131) from a sheet of material (111) to resist cyclical loading is also disclosed, as is a method to increase the fatigue resistance of a structure (131) formed by bending a sheet of material (111) along a bend line (115) having a plurality of bend-inducing structures (113).

### CROSS-REFERENCES TO RELATED APPLICATIONS

This application claims priority to U.S. Provisional Patent Application No. 60/587,470, filed Jul. 12, 2004, entitled METHOD FOR INCREASING THE FATIGUE RESISTANCE OF STRUCTURES FORMED BY BENDING SLIT SHEET MATERIAL AND PRODUCTS RESULTING THEREFROM, the entire contents of which is incorporated herein by this reference.

This application is also a Continuation-in-Part Application of U.S. patent application Ser. No. 10/672,766, filed Sep. 26, 2003, and entitled TECHNIQUES FOR DESIGNING AND MANUFACTURING PRECISION-FOLDED, HIGH STRENGTH, FATIGUE-RESISTANT STRUCTURES AND SHEET THEREFOR, which is a Continuation-in-Part Application of U.S. patent application Ser. No. 10/256,870, filed Sep. 26, 2002, and entitled METHOD FOR PRECISION BENDING OF SHEET OF MATERIALS, SLIT SHEETS FABRICATION PROCESS, now U.S. Pat. No. 6,877,349, which is a Continuation-in-Part Application of U.S. patent application Ser. No. 09/640,267, filed Aug. 17, 2000, and entitled METHOD FOR PRECISION BENDING OF A SHEET OF MATERIAL AND SLIT SHEET THEREFOR, now U.S. Pat. No. 6,481,259, the entire contents of which is incorporated herein by this reference.

### BACKGROUND OF THE INVENTION

1. Field of the Invention

The present invention relates, in general, to the bending of sheets of material having bend-inducing structures formed therein, such as slits, grooves, perforations or steps, and more particularly, relates to improving the resistance of structures formed by bending such sheets to fatigue failure during cyclical loading.

2. Description of Related Art

A commonly encountered problem in connection with bending sheet material using conventional sheet bending equipment, such as a press brake, is that the locations of the bends are difficult to control because of bending tolerance variations and the accumulation of tolerance errors. For example, sheet metal may be bent along a first bend line within certain tolerances. A second bend, however, often is located based upon the first bend, and accordingly, the tolerance errors can accumulate. Since there can be three or more bends which are involved to create an enclosure or closed structure, the effect of cumulative tolerance errors in conventional prior art bending techniques can be significant.

One approach to this problem has been to try to control the location of bends in sheet material through the use of bend-inducing or bend-controlling structures, such as slits, grooves, perforations or the like. Bend-inducing structures can be formed in sheet stock at very precise locations, for example, by the use of computer numerically controlled (CNC) devices to manipulate lasers, water jets, punch presses, knives or even single point tools.

Slits, grooves, perforations, dimples and score lines have been used in various patented systems as bend-inducing or producing structures for bending sheet material. U.S. Pat. No. 6,640,605 to Gitlin et al. employs parallel offset slits to create bendable sheets in which connecting twisted'straps or “stitches” span across the bend line. The Gitlin et al. slitting technique was developed to achieve decorative affects, and the resulting bends were reinforced in most applications to provide the necessary structural strength. U.S. Pat. No. 5,225,799 to West et al. uses a grooving-based technique to fold up a sheet of material to form a microwave wave guide or filter. In U.S. Pat. No. 4,628,661 to St. Louis, score lines and dimples are used to fold metal sheets. In U.S. Pat. No. 6,210,037 to Brandon, slots and perforations are used to bend plastics. The bending of corrugated cardboard using slits or die cuts is shown in U.S. Pat. No. 6,132,349 and PCT Publication WO 97/24221 to Yokoyama, and U.S. Pat. Nos. 3,756,499 to Grebel et al. and 3,258,380 to Fischer, et al. Bending of paperboard sheets also has been facilitated by slitting, as is shown in U.S. Pat. Nos. 5,692,672 to Hunt, 3,963,170 to Wood and 975,121 to Carter.

In most of these prior art sheet bending systems, however, the bend-inducing structures greatly weaken the resulting structure, or the bend-inducing structures do not produce the desired precision in the location of the bends, or both.

The problems of precision bending and retention of strength are much more substantial when bending metal sheets, and particularly metal sheets of substantial thickness. In many applications it is highly desirable to be able to bend metal sheets with low force, for example by hand, with using only hand tools or with only moderately powered tools.

Well known conventional fabrication techniques for producing rigid three-dimension structures include the joining together of sheet material by jigging and welding, or clamping and adhesive bonding, or machining and using fasteners. In the case of welding, problems arise in the accurate cutting and positioning of the individual pieces during welding, and the labor required to manipulate a large number of parts is significant, as are the quality control and certification burden. Additionally, welding has potential problems in connection with dimensional stability caused by the heat affected zone of the weld.

Welding of metal sheets or plates having significant material thickness is often achieved using parts having beveled edges made by grinding or single point tools. This adds significantly to the fabrication time and cost. Moreover, fatigue failure of heat affected metals under cyclical loading is a problem for joints whose load bearing geometries are based upon welding, brazing or soldering.

A new system for precise bending of sheet material, including thick sheets, has been devised in which improved bend-inducing or bend-controlling structures are employed. The bend-inducing structures are configured and positioned in a manner such that the three-dimensional structure resulting upon bending of the sheet has substantially improved strength and dimensional precision as compared to prior art slitting techniques, such as, for example, are disclosed in the Gitlin et al. U.S. Pat. No. 6,640,605. The position and configuration of these new and improved bend-inducing structures facilitate bending of the sheet precisely along the bend line, most preferably by causing edge-to-face engagement of the sheet material on opposite sides of the bend-inducing structures during the entire bend for control of the bend location.

The configurations and positioning of these new and improved bend-inducing slits, grooves and steps are described in much more detail in the above set forth Related Applications, which are hereby incorporated by reference in their entireties into this application.

Using the improved bend-inducing structures for bending sheet material has many advantages, not the least of which is the ability to use a series of precisely located bends to close the sheet of material back upon itself during bending, for example, in order to fabricate a box beam. Press brake bending, by contrast, is not well suited to form closed structures such as box beams. Box beams are exemplary of structures that have many applications and have heretofore been formed more traditionally by welding together of metal sheets or plates, rather than by bending of a single sheet or plate into a closed hollow beam structure.

Bending sheet material to form a box beam has substantial cost-saving advantages over fabrication of the beam by welding, if the resultant beam has substantially the same strength, and if it does not fail prematurely due to fatigue during the cyclical loading. When a box beam is loaded during use, it typically will be loaded transversely to its length, that is, transversely to the longitudinally extending corners of the beam along which the sheets or plates are welded together, or in the case of a folded single sheet, along the longitudinally extending bend lines. Such loading is often cyclical and results in fatiguing of the beam at its corners. For welded box beams, therefore, fatigue failure typically occurs along the welded corners, and if a bent sheet is to be used, the corner bend tines will also be the area most likely to fail.

Accordingly, it is an object of the present invention to provide a method for increasing the fatigue resistance of structures formed by bending slit sheet material.

It is another object of the present invention to provide an improved configuration of a bend-inducing structure for sheet material that will substantially improve the fatigue resistance of three-dimensional object formed by bending the sheet material.

A further object of the present invention is to provide increased fatigue resistance in bent sheet material and improve strength at the bend line of the sheet material.

Still a further object of the present invention is to provide a method and apparatus for enhancing the fatigue resistance of bent, slit sheet material which does not undesirably increase the fabrication costs, can be applied to a wide range of structures, and is adaptable for use with sheets of various thicknesses and types of materials.

The method and apparatus of the present invention have other objects and features of advantage which will become apparent from, or are set forth in more detail in, the accompanying drawing and the following description of the Best Mode of Carrying Out the Invention.

### BRIEF SUMMARY OF THE INVENTION

In one aspect, the present invention is comprised of a sheet of material formed for bending along a bend line and having a plurality of bend-inducing structures configured and positioned to produce bending along the bend line. At least one of the bend-inducing structures, and preferably all of them, have arcuate return portions extending from opposite ends of the bend-inducing structure and returning along the bend-inducing structure toward the other return portion. The return portions each are configured to significantly increase resistance to fatigue resulting from cyclical loads oriented in a direction transverse to the bend line by having arcuate lengths and radii reducing stress concentrations. The bend-inducing structures preferably are slits, grooves or steps which are configured to produce edge-to-face engagement on opposite sides of the bend-inducing structures during bending. Stress concentrations can be reduced by forming the arcuate return portions with a cord length at least approximately twice the thickness dimension of the sheet of material. The arcuate return portions further preferably have chords oriented substantially parallel to the bend line, and a radii of curvature of the return portions which are at least approximately three times the thickness dimension of the sheet of material.

In another aspect of the present invention a method of increasing the fatigue resistance of a structure formed by bending a sheet of material along a bend line having a plurality of bend-inducing structures is provided. The method comprises, briefly, the step of forming the bend-inducing structures to extend along the bend line and have arcuate return portions extending from opposite ends of the bend-inducing structures back along the bend-inducing structures toward the other return portion. The return portions have a length dimension along the bend line and a radius of curvature selected to be sufficiently large to significantly increase resistance to fatigue upon cyclical loading of the structures transverse to the bend line.

### BRIEF DESCRIPTION OF THE DRAWINGS

FIG. 1 is a top plan view of a sheet of material having bend-inducing structures formed therein as shown in the Related Applications.

FIG. 2 is a top plan, schematic representation of the slits of FIG. 1, and FIG. 2A is an enlarged, top plan view of the ends of the slits of FIG. 2.

FIG. 3 is a top plan, schematic representation corresponding to FIG. 2 of an alternative embodiment of the slits showing arcuate return portions.

FIG. 3A is an enlarged, top plan view of an end of the slit of FIG. 3.

FIG. 4 is a top plan, schematic representation corresponding to FIG. 2 of a further alternative embodiment of the slits showing an extended arcuate return portions.

FIGS. 4A and 4B are enlarged, top plan views of the end of the slit of FIG. 4.

FIG. 5 is a top plan, schematic representation corresponding to FIG. 2 of a further alternative embodiment of slits having a configuration and constructed in accordance with the present invention.

FIGS. 5A and 5B are enlarged, top plan views of the end of the slit of FIG. 5.

FIG. 6 is a schematic, side elevation view of a fatigue test stand with a box beam constructed using the slit configurations of FIG. 4 in position for testing.

FIG. 6A is an end view of the beam of FIG. 6.

FIG. 7 is a graph of stress versus cycles-to-failure for beams tested using the fatigue test stand of FIG. 6 and showing welding curves for class B to class G welds.

FIG. 8 is a table showing the test results for the beams tested using the test stand of FIG. 6.

### DETAILED DESCRIPTION OF THE INVENTION

Reference will be made in detail to the preferred embodiment of the invention, an example of which is illustrated in the accompanying drawings. While the invention will be described in conjunction with the preferred embodiment, it will be understood that it is not intended to limit the invention to that embodiment. On the contrary, the invention is intended to cover alternatives, modifications and equivalents, which may be included within the spirit and scope of the invention as defined by the appended claims.

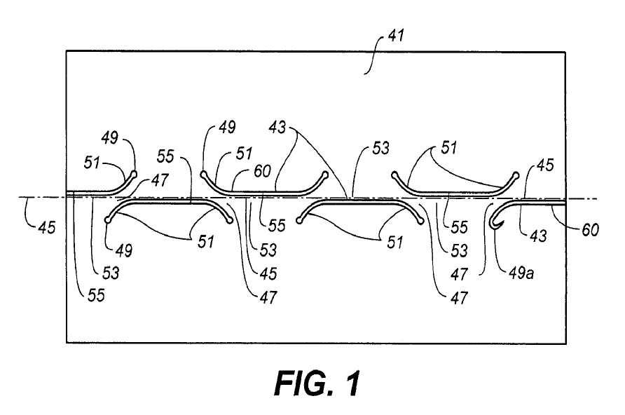

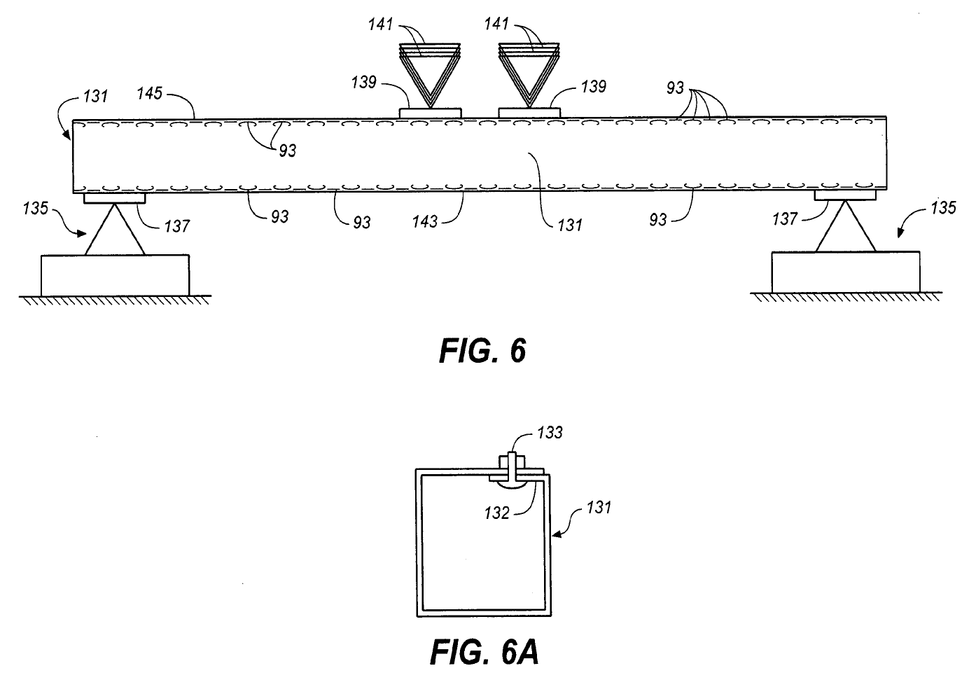

The present method and apparatus for precision bending of sheet material is based upon the bend-inducing slits, grooves or steps disclosed in the above-identified Related Applications, and particularly, as disclosed in application Ser. No. 10/672,766, filed Sep. 26, 2003 and entitled TECHNIQUES FOR DESIGNING AND MANUFACTURING PRECISION-FOLDED, HIGH STRENGTH, FATIGUE-RESISTANT STRUCTURES AND SHEETS THEREFOR. FIG. 6 of application Ser. No. 10/672,766 has been incorporated in this application as FIG. 1 to illustrate the changes made by the present invention to the slit groove or step configurations in order to increase fatigue resistance.

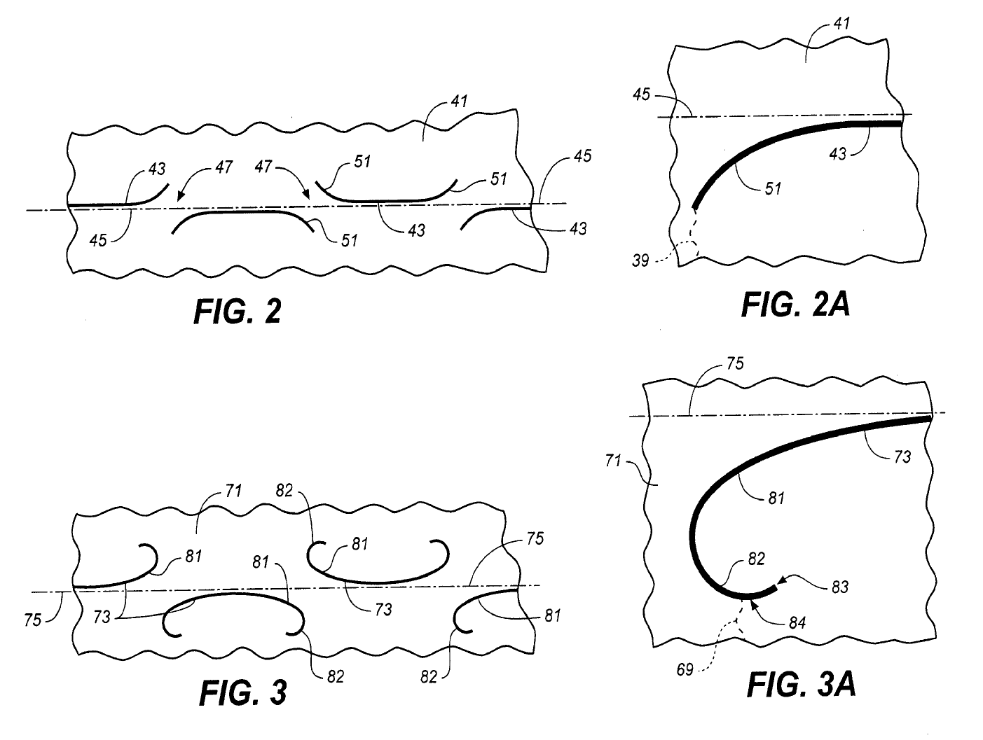

Referring specifically to FIG. 1, a sheet of material 41 to be bent or folded along a bend line 45 is formed with a plurality of longitudinally extending bend-inducing structures. These bend-inducing structures may be any one of slits, grooves or steps 43 positioned along bend line 45, but for brevity they will be referred to herein as “slits” or “bend-inducing structures.” Each bend-inducing structure 43 is shown as having a kerf in FIG. 1 and essentially no kerf in FIGS. 2 through 5B. The presence or absence of a kerf does not form a part of the present invention. Slits 43 also have enlarged stress-relieving end openings 49, or a curved end section 49a (the slit on the right-hand end of FIG. 1). In addition, the slits may have a curved end. Curved end 49a terminates the slits in a relatively low stress zone, thereby decreasing the likelihood that cracking will initiate at a terminus of the curved end. Slits 43 are configured in a manner producing bending and twisting of obliquely oriented bending straps 47 about a virtual fulcrum superimposed on bend line 45. The configuration and positioning of the bend-inducing structures, including selection of the jog distance and kerf width, causes the sheet material on opposite sides of the bend-inducing structures to tuck or to move into an edge-to-face interengaged relationship during bending, as is set forth in detail in the Related Applications and will not be repeated herein. Most preferably, edge-to-face interengagement occurs throughout the bend to its completion; but, the jog distance and kerf also can be selected to produce edge-to-face interengagement only at the start of the bend, which also will tend to ensure precise bending. Thus, as used herein, the expression “during bending” is meant to include edge-to-face interengagement at any stage of the bend that will produce precise bending. Interengagement only at the end of the bend will not control the location of the bend with the same degree of precision.

As shown in FIG. 1, pairs of elongated slits 43 are preferably positioned on opposite sides, of and proximate to, bend line 45 so that pairs of longitudinally adjacent slit end 51 on opposite sides of the bend line define a bending web, spline or strap 47, which can be seen to extend obliquely across bend line 45. “Oblique” and “obliquely,” shall mean that the longitudinal central axis of straps 47 cross the bend line, and cross at an angle other than 90 degrees. Thus, each slit, groove or step end portion 51 diverges away from bend line 45 so that the center line of the strap is skewed or oblique to the bend line. This produces bending as well as twisting of the strap.

Unlike the slits or grooves of the prior art Gitlin, et al. U.S. Pat. No. 6,640,605, which are parallel to the bend line in the area defining the bending straps, the divergence of the bend-inducing structures 43 from bend line 45 results in oblique bending straps that do not require the extreme twisting present in the straps of the Gitlin, et al. patent. Moreover, the divergence of bend-inducing structures 43 from bend line 45 results in the width dimension of the straps increasing as the straps connect with the remainder of sheet 41. This increasing width enhances the transfer of loading across the bend so as to reduce stress concentrations and to increase fatigue resistance of the straps.

As above noted, the width or kerf of slits and the transverse jog distance across the bend line between slits, are preferably dimensioned to produce interengagement of sheet material on opposite sides of the slits during bending. If the kerf width and jog distance are so large that contact does not occur, the bent or folded sheet will still have some of the improved strength and fatigue-resistance advantages of oblique bending straps. In such instances, however, there are no actual fulcrums for controlled bending to occur so that bending along bend line 45 becomes less predictable and precise. Similarly, if the strap defining structures are grooves 43 which do not penetrate through the sheet of material, the grooves will define oblique, high-strength bending straps, but edge-to-face sliding will not occur during bending unless the groove is so deep as to break-through during bending and become a slit.

It is also possible for the slits 43 to actually be on the bend line or even across the bend line (a negative jog distance) and still produce precise bending from the balanced positioning of the actual fulcrum faces 55 and the edges of lips 53 sliding therealong. A potential disadvantage of bend-inducing structures 43 being formed to cross the bend line 45 is that an air-gap would remain between the opposed edges and faces. An air-gap, however, may be acceptable in order to facilitate subsequent welding, brazing, soldering, adhesive filling or if an air-gap is desired for venting.

In the slit sheet of FIG. 1, both oblique bending straps 47 and stress-reducing opening or enlargements 49 have been employed in an attempt to increase the resistance to fatigue failure of the structure formed by bending sheet 41. Additionally, the right-hand slit or groove 43 has been formed with an arcuate return portion or extension 49a in order to terminate slits 43 in a zone of relatively low stress. While effective to some extent, these strategies for increasing the fatigue resistance of bend-inducing slits, grooves or steps sill have not achieved the fatigue resistance that is desirable for structures which are subjected to repeated heavy cyclical loading.

More particularly, box beams which are formed using the sheet slitting, grooving or step-forming techniques as taught by the above-identified Related Applications are often subjected to cyclical loading in bending. Such loading can cause premature fatigue failure of the beams, with disastrous effects.

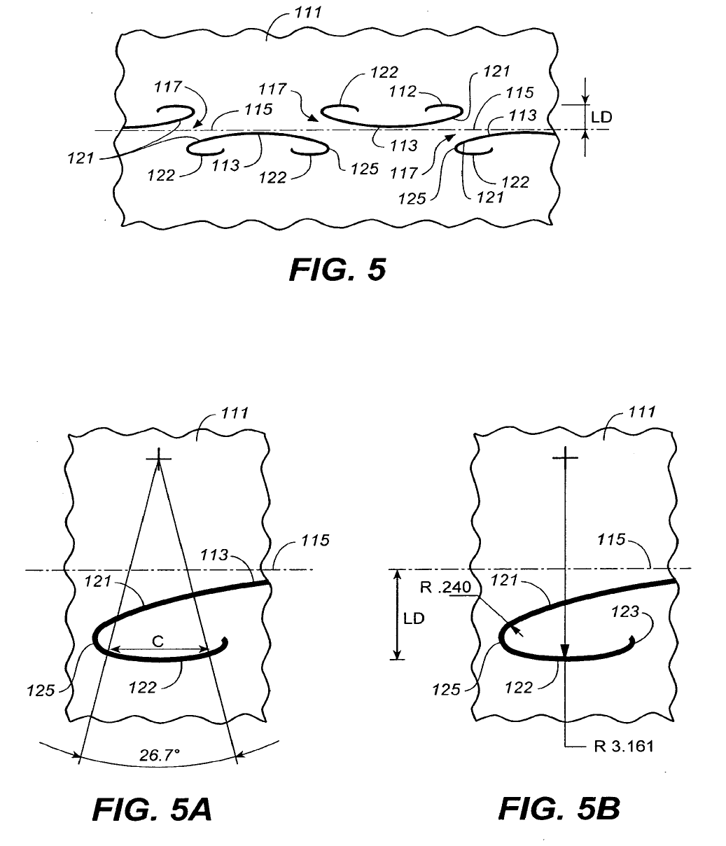

FIGS. 2, 2A, 3, 3A, 4, 4A and 4B schematically illustrate the evolution of the configuration of the bend-inducing structures which have resulted in the greatly improved, fatigue-resistant geometry shown in FIGS. 5, 5A and 5B.

FIGS. 2 and 2A correspond to FIG. 1 except that the bend-inducing structures 43 are shown with ends 51 which do not have stress-relieving openings or enlargements 49, as shown in FIG. 1. Similarly, ends 51 in FIGS. 2 and 2A do not have a return portion 49a which curves back along the slits.

In FIGS. 2 and 2A, diverging slit ends 51 again define oblique bending straps 47, which will produce precise bending of sheet 41 along bend line 45. When the sheet of FIGS. 2 and 2A is bent and then loaded transversely to bend line 45, failure of the resulting structure under cyclical loading will most likely occur at the ends of slits 43, as schematically shown in broken lines at 39 in FIG. 2A. Crack 39 will propagate transversely away from bend line 45 and can cause failure of the three-dimensional structure formed by bending sheet 41.

In FIGS. 3 and 3A, sheet 71 is formed with a plurality of bend-inducing structures, such as slits 73, which are positioned relative to bend line 75 in a manner taught by the Related Applications. In the embodiment shown in FIGS. 3 and 3A, end portions 81 of the slits are formed with relatively large diameter arcuate return portions 82. Thus, the return portions 82 are similar in concept to that shown in FIG. 1 by arcuate end 49a, but the radius of curvature of end return portions 82 is much greater than was the case for return portion 49a. Again, the concept is to bring any stress-increasing crack tips to a low stress zone so that cracks do not initiate from the tips.

It was discovered, however, that when a three-dimensional structure was formed by bending sheet 71 along bend line 75, and thereafter the structure was loaded transversely to bend line 75, fatigue failure did not occur at end 83 of return portion 82, but instead, occurred, as shown by broken line 69, proximate point 84 of return portion 82 which is farthest away from bend line 75.

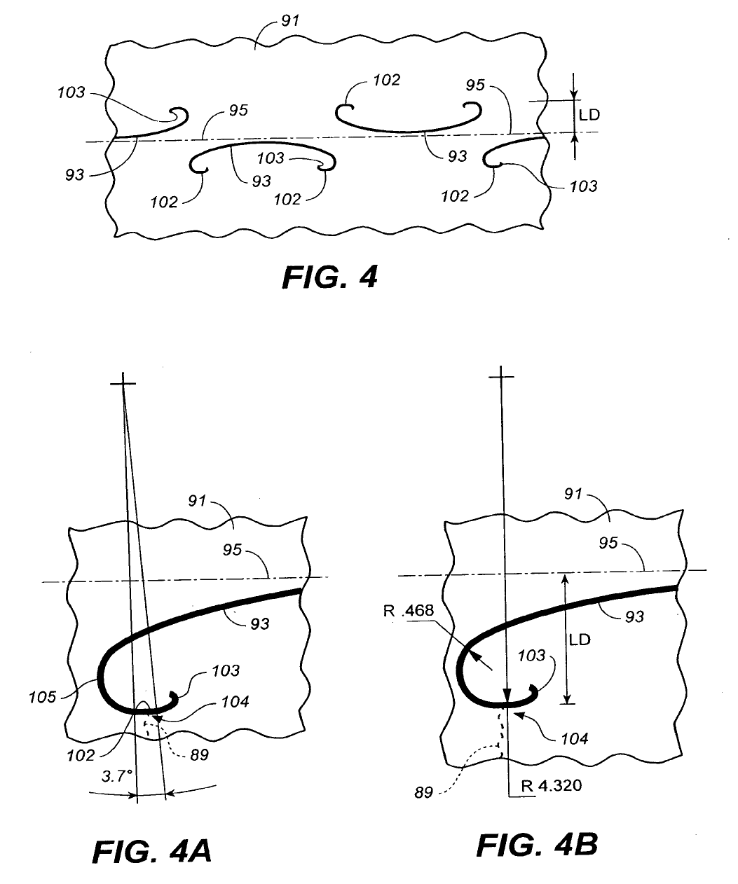

In an effort to attempt to avoid the stress concentration resulting from the configuration of arcuate return portion 82, sheet 91 in FIGS. 4, 4A and 4B was formed with bend-inducing slits 93 along bend line 95 As best may be seen in FIGS. 4A and 4B, the bend-inducing structures are formed with return portions 102 which flatten out or have relatively larger radii of curvature in the area which failure might occur. The return portions then hook back in at 103, again to attempt to avoid stress concentration at the end of the bend-inducing structures. When bent along bend line 95 and then transversely loaded, however, cracking again occurred upon failure of the structure at crack 89, shown by a broken line in FIGS. 4A and 4B. This cracking occurred at 104, which is approximately the position which is furthest from bend line 95.

FIGS. 5, 5A and 5B illustrate the configuration bend-inducing slits, grooves or steps which have been found to have substantially increased resistance to fatigue failure. This configuration is also shown in prior application Ser. No. 10/672,766 as FIG. 11.

In FIG. 5, a sheet of material 111 has been slit, grooved or stepped with bend-inducing structures 113 along bend line 115 in a manner as set forth in the above-identified Related Applications. The bend-inducing structures 113 are generally continuous compound arcuate shapes and have end portions 121 which define bending straps 117 that extend obliquely across bend line 115 in a manner also described above and in the Related Applications. Arcuate return portions 122 are provided on opposite ends 121 of bend-inducing slits 113, with ends 121 being connected to return portions 122 by relatively smaller diameter arcs 125. Each return portion 122 returns along bend line toward the other return portion. Finally, the return portions most preferably include ends 123 which hook or extend back toward bend line 115.

As will be seen from the Examples set forth hereinafter, a dramatic improvement in the fatigue resistance of the bent structures formed using the slit configuration of FIG. 5 over that of FIG. 4, and over that of commercially available welding, has been experienced.

Comparing the slits of FIGS. 4 and 5, the dramatic increase in resistance to fatigue is believed to reside in one or more of the following factors. First, the length of the arcuate return portion 102 in FIG. 4A can be seen to be substantially shorter than the length of the arcuate return portion 122 in FIG. 5A. The ends of the slits in FIG. 4 are continuous curves which transition from end radius 105 to return radius 102 and then to the terminal radius 103. The arc angle of the return 102 for the FIG. 4 slits was only 3.7 degrees. The arc angle for the slits of FIG. 5, by contrast, was 26.7 degrees. Thus, the chord subtended by arc 122 in FIG. 5A is much longer than the chord in FIG. 4A. This is believed to be very important in avoiding stress risers which will produce fatigue failure.

Another way of expressing this increased return length is that return portions 122 extend along the slit by a much greater percentage of the slit length than is the case for return portions 102. Thus, the chord lengths of return portions 122 are on the order of about 20% of the overall slit length in the FIG. 5 configuration, while they are only about 4% of the slit length in the FIG. 4 configuration. Most preferably, and as is the case in both configurations, the return portion chords are substantially parallel to the bend lines 95 and 115, respectively.

The radius of return portion 102 in FIG. 4B, however, is actually longer than the radius of curvature of return portion 122 in FIG. 5B. The radius of curvature of return 102 in FIG. 4B is 4.32 times the thickness of the sheet of material, which was 0.125 inches in this case. In FIG. 5B, the radius of curvature of return portion 122 can be seen to be only 3.161 times the thickness dimension of the sheet of material, also 0.125 inches. While it is believed that the radius of curvature of the return portion should not be too small so as to arc away from the bend line 115 in a manner which provides a site for stress risers, over a level, which is not yet known, there is believed to be a reasonable amount of latitude with respect to the radius of curvature of the return portion.

As will also be seen from FIGS. 4B and 5B, the radius of curvature of end portion 125 is less than the radius of curvature of end portion 105. Thus, a radius of 0.124 times the thickness dimension of the sheet of material is employed in the slits of FIG. 5B, while a radius of 0.468 times the thickness dimension of the sheet of material is employed in the slits of FIG. 4B. The lateral distance, LD, to position 104 in FIG. 4 from bend line 95 is significantly greater than the lateral distance, LD, of the equivalent position in the geometry of FIG. 5B.

Minimizing the lateral distance to which the slits extend away from the bend line is thought to be important because the slits cut into the native material on either side of the bend line. When the beam is loaded as shown in FIG. 6, the bottom side 143 of the beam will be under tension so that a band of native material just above the slits will be called upon to resist the tension forces along the length of the beam. As the arcuate slits have an end radius 105 which increases, the band of unbroken native material moves away from the bend line by the lateral distance, LD (see FIG. 5B), subjecting it to more stress in resisting the tension loading forces.

At this point, sufficient testing has not been conducted in order to generate complete curves as to the effects of return portion arc angles, return portion radii, or end arc radii (lateral distances into the native material) so as to demonstrate where the substantially enhanced fatigue resistance begins to be significant. It is believed that these are likely to be continuous curves with the arc angle of the return portion being the most critical factor. It is also believed that the configuration of FIG. 5 will scale off of the thickness dimension of the sheet of material. Since the improvement in fatigue resistance allows a beam to be folded from sheet material and have a fatigue resistance many times that which can be achieved in welded equivalent structures, the exact point at which the performance exceeds a welded structure's performance may tend to be somewhat academic. Suffice it to say that the configuration of FIGS. 5, 5A and 5B will substantially out perform box beams which are welded together from plate material in fatigue resistance.

### EXAMPLES

FIG. 6 schematically illustrates a box beam as positioned on a fatigue test stand. The box beams tested each had a square cross-section with a dimension of 4 inches on each side and included a flange 132 which was folded inside one of the sidewalls and secured thereto by fastener assemblies 133, in this case a bolt and nut. The fasteners were placed every 4 inches along the length of the beam, and beam 131 had an overall length of 48 inches. A support assembly 135 was provided proximate each end of beam 131, and forced distributing plates 137 used to avoid local concentrations of stress at support stands 135.

Beam 131 was loaded at two locations 139 on either side of the center of the beam. The loads were spaced from each other by a distance of approximately 6 inches. Again, load distributing plates were employed at 139, and arrows 141 schematically illustrate that the beam was loaded from a minimum load up to a maximum load. Loading was cycled between minimum and maximum load until beam failure occurred: As will be seen from FIGS. 6 and 6A, therefore, a bottom side 143 of the beam was cycling in tension, while a top side 145 was compressed under the transverse bending load of the beam. In each case, failures occurred along bottom side 143 of the beam with cracks propagating upwardly from side 143 towards side 145.

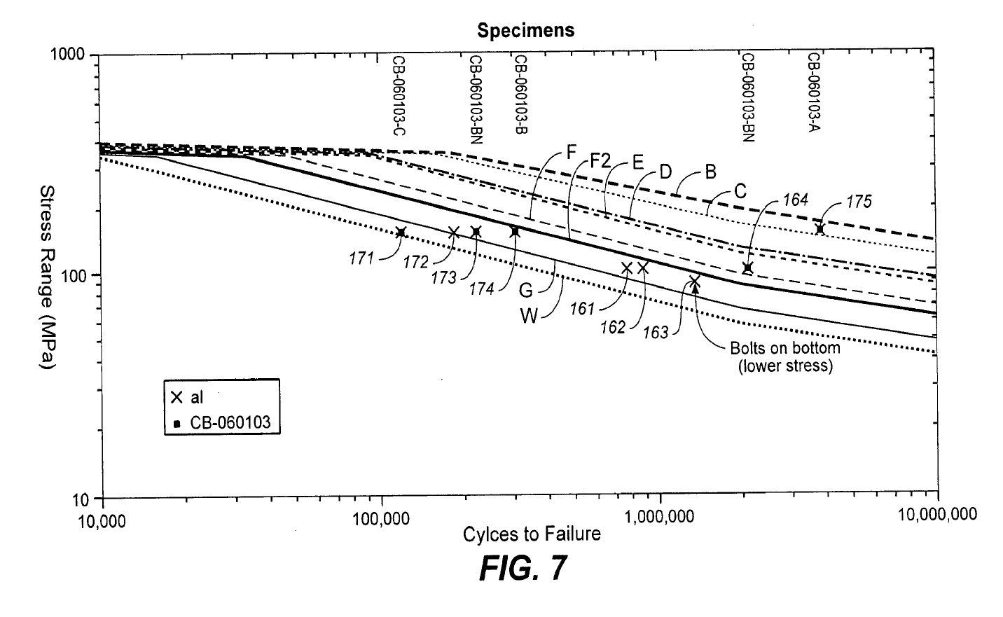

FIG. 7 shows the test results for various beams which were tested using the test stand of FIG. 6. The stress was measured in Mega-Pascals, (MPa), and has been plotted versus Cycles to Failure. Also, shown on FIG. 7 are the Cycles to Failure curves for welded box beams, as a function of the class of the weld. Thus, a class B weld is shown as the top curve, while a class G weld is the bottom curve. The data represented by the “class B weld” to “class G weld” curves was generated testing “class B weld” through “class C weld” steel box beams, which beams are welded at the corners using the various welding class standards, which are known in the industry. Typically, commercially available box beams will be welded at the level of a class F weld.

The data points on FIG. 7 were for two types of box beams, namely one series using the slits of FIG. 4 and the other series using the slits of FIG. 5. When the initial tests were run, the trial load range was relatively low, namely 17.5 (e.g., Stress Range of approximately 90-100 MPa). Data points 161, 162, 163 and 164 were all run using the lower magnitude of cyclical loading as a trial. The data points 161, 162 and 163 are all for box beams formed using the slit of FIG. 4. The data point 164 is for a box beam having FIG. 5 slits and having a trial load of 17.5 (e.g., Stress Range of approximately 100 MPa), but the beam did not fail at data point 164.

It was decided that the load range should be increased for final testing and data points 171, 172, 173, 174 and 175 are for beams which were loaded with a load range of 26 (e.g., Stress Range of approximately 150 MPa). Data points 172, 173 and 174 are for box beams folded from sheet material formed with slits having the configurations of FIG. 4 while data points 171 and 175 are for box beams which were folded from sheets slit in accordance with FIG. 5.

Data point 171 is a relatively early failure which occurred in a FIG. 5 box beam, not because the beam failed at any of the slits, but because the beam went out of square into a rhombus mode during cycling. This rhombus mode cycling resulted in a premature failure. Data points 164 and 175 are for the same type of beam, namely a beam with FIG. 5 slits. The beam was cycled up to 2,100,000 cycles at the low trial load range of 17.5 (e.g., Stress Range of 100 MPa) and, since no failure occurred, the loading was then increased to 26 (e.g., Stress Range of 150 MPa). The beam loading was then continued up to 3,827,753 cycles, at which point the test could not be completed because the failure occurred at one of the load points 139, indicating that failure was not purely a function of the beam's characteristics but instead a function of the beam/test configuration. Thus, the test essentially was not completed to find the ultimate real limit of beams having FIG. 5 slits.

As will be seen, data point 175 is above the curve for a class C weld, much less that of a class F weld, the commercially available welds. A class F weld would fail, on average, at about 600,000 cycles at the load range of 26 (e.g., Stress Range of approximately 150 MPa). Thus, a bent or folded box beam using the slit configuration of FIG. 5 has more than six times the cycling capacity of a commercially welded, class F, box beam, and the upper limit of the box beam of the present invention is still not known.

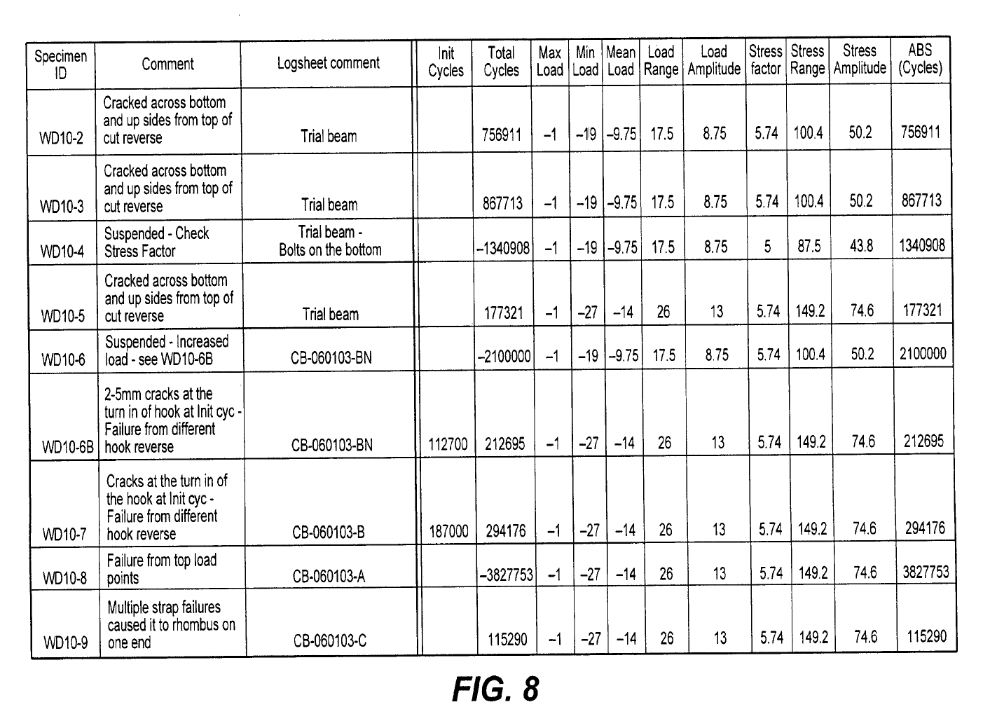

FIG. 8 shows a table of the test results used to generate the data of FIG. 7.

The foregoing descriptions of a specific embodiment of the present invention has been presented for the purpose of illustration and description. It is not intended to be exhaustive or to limit the invention to the precise form disclosed, and obviously many modifications and variations are possible in light of the above teaching. The embodiment was chosen and described in order to best explain the principles of the invention and its practical application to thereby enable others skilled in the art to best utilize the invention and the embodiment with various modifications as are suited to the particular use contemplated. It is intended that the scope of the invention be defined by the claims appended hereto and their equivalents.

1-32. (canceled)

33. A sheet of material formed for bending along a bend line comprising:
a sheet of material having a plurality of bend-inducing structures configured and positioned to produce bending along the bend line, at least one bend-inducing structure having arcuate return portions extending from opposite ends of the bend-inducing structure;
wherein the arcuate return portions return along the bend-inducing structure toward the other return portion; and
wherein the arcuate return portions curve back toward the bend line at distal ends of the return portions.

34. The sheet of material as defined in claim 33, wherein the bend-inducing structures are one of slits, grooves and steps.

35. The sheet of material as defined in claim 34, wherein the bend-inducing structures are configured and positioned to produce edge-to-face engagement of the sheet of material on opposite sides of the bend-inducing structures during bending.

36. The sheet of material as defined in claim 33, wherein the return portions are each configured to significantly reduce stress concentrations resulting from loads oriented in a direction transverse to the bend line.

37. The sheet of material as defined in claim 36, wherein the arcuate return portions have a radius of curvature section over a majority of their length of at least about 2 times the thickness dimension of the sheet of material.

38. The sheet of material as defined in claim 36, wherein at least one of the bend-inducing structures is an arc having a convex side facing and extending along the bend line, and each of the opposite ends of the arc transition to the respective return portion along an arc having a radius of curvature of between about 0.1 to about 1.0 times the thickness dimension of the sheet of material.

39. The sheet of material as defined in claim 36, wherein the transverse dimension of the bend-inducing structure from the bend line is less than about 20 percent of the overall length dimension of the bend-inducing structure.

40. The sheet of material as defined in claim 33, wherein the radii of curvature of the return portions are at least about 5 times the radii of curvature of the opposite ends of the bend-inducing structure.

41. The sheet of material as defined in claim 33, wherein the opposite ends have a first radius of curvature less than the thickness of the sheet of material, and the arcuate return portions have a second radius of curvature several times greater than the thickness of the sheet of material.

42. A sheet of material as defined in claim 41, wherein the first radius of curvature is about 0.124 to about 0.468 times the thickness of the sheet of material.

43. A sheet of material as defined in claim 42, wherein the second radius of curvature is about 3.161 to about 4.320 times the thickness of the sheet of material.

44. The sheet of material as defined in claim 33, wherein the arcuate return portions have chords oriented substantially parallel to the bend line, each of the return portions having a chord length along the bend line at least about 20 percent of the length of the bend-inducing structure along the bend line.

45. The sheet of material as defined in claim 33, wherein the sheet of material is bent along the bend line into a three-dimensional structure suitable for loading transversely to the bend line.

46. A method of increasing the fatigue resistance of a structure formed by bending a sheet of material along a bend line having a plurality of bend-inducing structures, the method comprising:
forming the sheet of material with the plurality of bend-inducing structures to produce bending of the sheet of material along the bend line;
bending the sheet of material along the bend line to produce a three-dimensional bent structure; and
during the forming step, forming at least one of the bend-inducing structures with opposite ends curving away from the bend line and arcuate return portions;
wherein the arcuate return portions curve away from the opposite ends and back along the slit toward the other return portion; and
wherein the return portions curve back toward the bend line at distal ends of the return portions.

47. The method as defined in claim 46, wherein the step of forming the bend-inducing structures with arcuate return portions is accomplished by forming the arcuate return portions to have a radius of curvature between about 2 and about 4 times the thickness dimension of the sheet of material.

48. The method as defined in claim 46, wherein during the forming step, forming the bend-inducing structures as one of slits, grooves and steps in the sheet of material.

49. The method as defined in claim 48, wherein during the forming step, forming the bend-inducing structures with a configuration producing edge-to-face engagement of the sheet of material on opposite sides of the bend-inducing structures during bending.

50. The method as defined in claim 46, and the step of: after the forming step, bending the sheet of material into a three-dimensional structure.

51. The method as defined in claim 46, wherein during the forming step, forming the arcuate return portions with a length dimension along the bend line and radius of curvature sufficient to substantially increase the resistance to fatigue failure when the structure undergoes transverse loading.

52. The method as defined in claim 46, wherein during the forming step, forming the arcuate return portions with chords oriented substantially parallel to the bend line, each of the return portions having a chord length along the bend line at least about 20 percent of the length of the bend-inducing structure along the bend line.
